(19) United States
(12) Patent Application Publication
(10) Pub. No.: US 2016/0205502 A1
(43) Pub. Date: Jul. 14, 2016

(54) METHOD AND SYSTEM FOR LOCATING AN ELECTRONIC DEVICE

(71) Applicant: Synchronoss Technologies, Inc., Bridgewater, NJ (US)

(72) Inventors: Jiren Parikh, Philadelphia, PA (US); Leon Podolsky, Princeton, NJ (US)

(73) Assignee: Synchronoss Technologies, Inc.

(21) Appl. No.: 14/995,760

(22) Filed: Jan. 14, 2016

Related U.S. Application Data
(60) Provisional application No. 62/103,205, filed on Jan. 14, 2015.

(51) Int. Cl. H04W 4/02

(52) U.S. Cl. CPC H04W 4/02

(57) ABSTRACT

A method and system for locating a target electronic device utilizes the wireless capabilities of multiple third party devices thereby allowing these devices to search for the target electronic device on a large scale. The third party devices electronically sense other electronic devices and report the location of the third part device when the target device is sensed.

### RELATED APPLICATIONS

This application claims benefit of priority under 35 USC §119(e) of the co-pending U.S. Provisional Patent Application Ser. No. 62/103,205, filed Jan. 14, 2015, entitled, “Method and System for Locating an Electronic Device,” which is hereby incorporated by reference in its entirety.

### FIELD OF THE INVENTION

Embodiments of the present disclosure generally relate to a system and method of electronically searching for an electronic target device. A more particular embodiment uses wirelessly networked electronic devices to locate an electronic target device.

### BACKGROUND

There may be numerous wireless networks available that operate simultaneously, such as Wi-Fi®, cellular, satellite, or Bluetooth®. Some electronic devices have the ability to sense or interact with one or more of these networks, and in some cases, they have the ability to sense other nearby electronic devices. It is desirable to use these networks to locate lost or missing electronic devices that don't have location detecting capability.

### SUMMARY

Embodiments of a system and method for locating an electronic device are provided herein. In an embodiment, a process for locating an electronic target device includes generating a search request seeking the target device and forwarding the search request by a server to one or more devices linked to the server through one or more networks. The one or more wirelessly linked devices wirelessly sense for nearby electronic devices, receive a signal from at least one of the linked devices which have sensed the target device, and transmit a location of the linked devices to the server.

In an embodiment, a system for locating a target device is disclosed. The system includes a server linked to one or more networks and electronic devices linked to the server through the one or more networks. After receiving a search request from the server identifying a target device, the linked electronic devices wirelessly sense other electronic devices within range and the linked electronics device sensing the target device transmits a location to the server.

In an embodiment, a locating system includes a server linked to one or more networks. One or more wireless technology-enabled electronic devices are linked to the server through the one or more networks. The locating system further includes a WPAN-enabled target device and a user device including software configured to communicate a prompt to the server, the prompt including an identification of the target device. After receiving the prompt from the user device, the server transmits to the one or more electronic devices a search request including the identification of the target device, the search request enabling all wireless technologies of the one or more electronic devices to enter a discovery mode to sense other electronic devices. At least one of the one or more electronic devices senses the target device and transmits geographical location data of the electronic device to the server; and the server communicates the location to the user device.

Other and further embodiments of the present invention are described below.

### BRIEF DESCRIPTION OF THE DRAWINGS

These and other features, aspects, and advantages of the disclosure will become better understood with regard to the following aspect of the present disclosure, appended claims, and accompanying drawings where:

FIG. 1 is a system diagram according to an aspect of the system of the present disclosure.

FIG. 2 is a flow diagram showing operation of the system according to an aspect of the present disclosure.

FIG. 3 an illustration showing the system.

FIG. 4 is a diagram displaying general purpose computer on which the system and method of the present disclosure may be implemented according to an aspect of the present disclosure.

### DETAILED DESCRIPTION

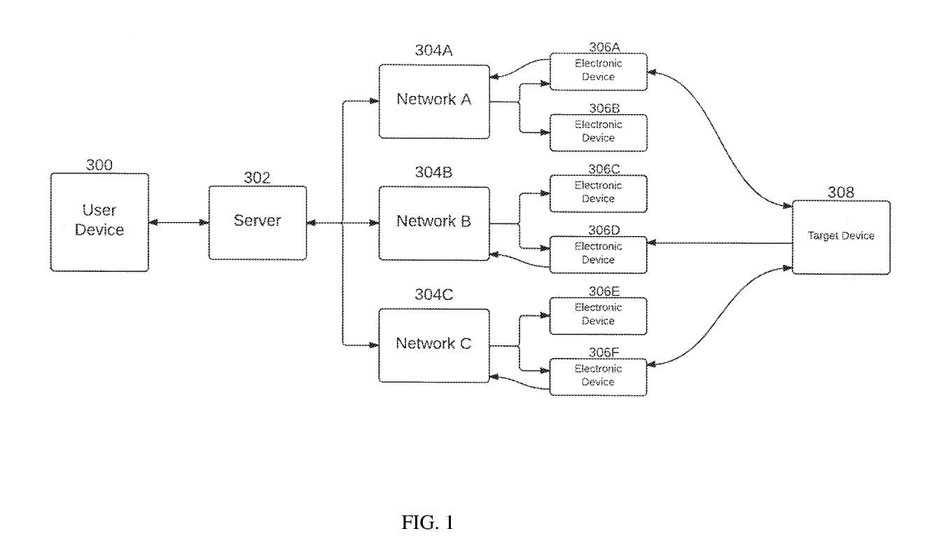

FIG. 1 is a system diagram showing a server 302, user's device 300, available networks 304A, 304B, 304C, one or more third party electronic devices 306A-F, and target device 308.

The server 302 may be a computer server. In a non-limiting embodiment, the server 302 may be a centralized server, dedicated to one user or client. In an embodiment, the server 302 may be a server associated with a wireless communications provider serving multiple clients. The server 302 is communicatively linked with one or more communications networks, for example networks 304A-C, for bidirectional communication. The server 302 may be linked to any one of the networks 304A-C, or to more than one network 304A-C.

Networks 304A-C are communicatively linked with one or more electronic devices 306A-F. At least some of the networks 304A-C are linked with the electronic devices 306A-C for bidirectional communication. Networks 304A, 304B, 304C may be any technologies permitting communication between two or more electronic devices 306A-F, such as wireless cellular networks, satellite communication networks utilized by governmental or commercial entities, or high frequency (e.g., super-high frequency (SHF) or ultra-high frequency (UHF)) radio communication such as Wi-Fi® and Bluetooth® used in wide area and near field local area networks. In some embodiments, the 2.4 gigahertz (UHF) or 5 gigahertz (SHF) radio frequency in the industrial, scientific, and medical bands (ISM bands) are used. Networks 304A, 304B, 304C may also be wire-based such as traditional local area network (LAN), cable, or digital subscriber line (DSL).

Electronic devices 306A-F and target device 308 may be any electronic device capable of sensing or interacting with another electronic device or one or more networks 304A, 304B, 304C including but not limited to: cellular phones, laptop computers, personal computers, routers, tablets, mobile music storage and playback devices, ear pieces, microphones, watches or jewelry. In some cases, components may be fitted to non-electronic devices to adapt the non-electronic devices to operate as electronic devices 306A-F or target device 308.

In an embodiment, the electronic devices 306A-F and the target device 308 are related. For example, they may be related because each of the electronic devices 306A-F and the target device 308 may be produced by the same manufacturer or group, may utilize the same operating system or wireless network provider, or may be under the possession and control of the same individual or group.

In an embodiment, the electronic devices 306A-F are third party electronic devices. As third party devices, the electronic devices 306A-F and the target device 308 are not related. The electronic devices 306A-F and the target device 308 may use different operating systems, may be manufactured by different entities, may be communicatively linked to different wireless network providers, based in different geographic regions, and may be possessed or controlled by individuals or groups unknown to each other. In an embodiment, the target device 308 is not linked to any wireless network or provider.

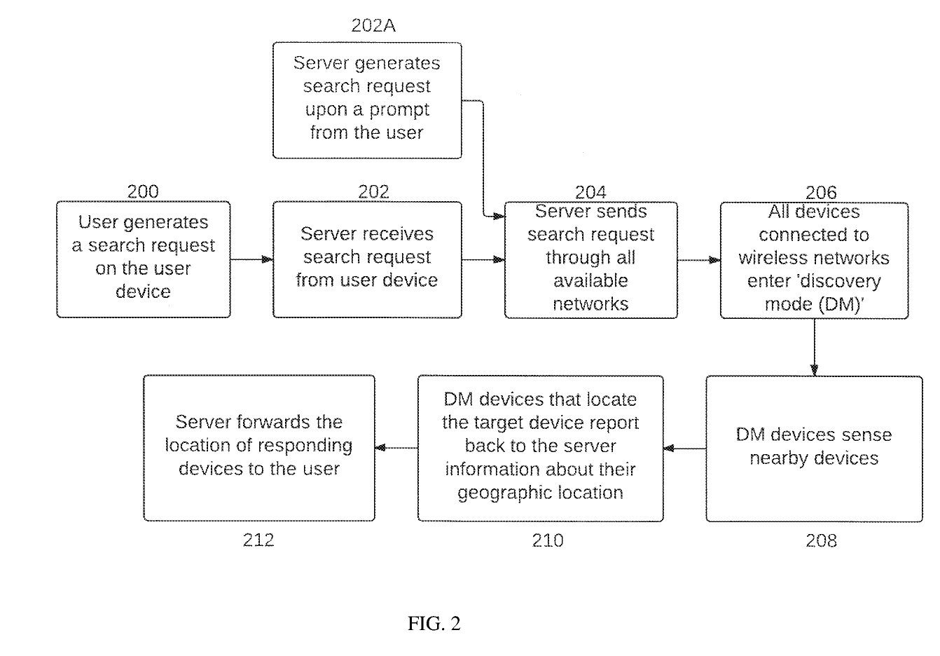

Referring now to FIG. 2, at 200, a user may input data into the user device 300 via a software application seeking to identify the geographic location of the missing target device 308. There are various ways that a user may input data into server 302 in order to begin the process. One example includes the user interacting with a software application on the user device 300, wherein all electronic device-specific identifications (IDs) associated with that particular user are accessible. The user may then select the device that he or she wishes to locate from a menu, and then the user device forwards that specific ID to the server 302. The ID of the electronic devices, for example target device 308 and electronic devices 306A-F, is a specific electronic identification associated with that device. The ID may be implemented in digital electronic circuitry, or in computer hardware, firmware, software, or combinations thereof, and is discoverable by other electronics devices via wireless networks as described above.

At 202, the server 302 receives a prompt, such as a search request, from the user device 300. The prompt is communicated to the server 302 using the wired or wireless technologies permitting communication between two or more electronic devices discussed above.

Alternatively, as shown in 202A, the server 302 may generate the search request after receiving a prompt from the user. For example, the specific ID's of millions of electronic devices may be stored on a centralized server 302. The user in this example may contact the server administration with information about the target device 308. Then, server personnel may call or select the target device 308 specific ID from the server 302 records thereby generating the search request. The server 302 may then forward the search request through all available networks 304A, 304B, 304C, at 204 thereby reaching all linked devices 306A-F.

At 206, upon receipt of the search request from the applicable network 304A, 304B, or 304C, the linked devices 306A-F may enter a ‘discovery mode,’ wherein the devices 306A-F may wirelessly sense other nearby electronic devices. When in ‘discovery mode,’ electronic devices 306A-F may operate differently from each other depending upon the wireless technologies they utilize. For example, one or more electronic devices 306A-C may operate using one or more of cellular, satellite, or high-frequency radio waves on an appropriate network after receipt of the search request.

When wirelessly sensing, the linked devices 306A-F receive the IDs of all other electronic devices within range. Those IDs that do not match the specific ID in the search request are ignored by the linked devices 306A-F.

Typically, a device operating on a wireless local area network (WLAN), such as a Wi-Fi® device, can only sense and identify another Wi-Fi® device via a Wi-Fi® network if one of the two is considered a ‘hotspot,’ meaning it is providing Wi-Fi® service to nearby devices. For example, a router (the hotspot) can sense all Wi-Fi® capable devices within its operating range, and these devices can likewise sense the router. However, two Wi-Fi® devices cannot sense each other unless one of them is also acting as a hotspot. Mobile Wi-Fi® hotspot features are available on some mobile devices today, allowing them to act like a router and therefore be discovered by nearby devices.

Typically, a wireless device using high-frequency radio technology such as Bluetooth® can passively sense and identify all other Bluetooth® enabled devices within its operating range when Bluetooth® is activated on both devices. Bluetooth® is a known wireless technology used in a wireless personal area network (WPAN). Technologies supporting a WPAN typically have an operating range of about 10-100 meters.

Devices using satellite or cellular technologies, or their equivalents, cannot sense other devices operating on the same satellite or cellular networks but can sense the device providing the service, such as a satellite or cellular tower. The satellite or cellular tower would likewise be able to sense all devices within the operating range of their respective channels.

In the examples provided above, the devices can sense and recognize each other without having to authenticate or pair up. This is possible because the specific IDs of the devices are immediately recognizable, even if other data is not transmitted. Consider again for illustrative purposes the example of a Wi-Fi® enabled device and a router. The device will recognize the router ID and location, and vice versa, but the device will not connect to the router or transmit data through the network without proper authentication. Additionally, Wi-Fi® enabled devices that have a hotspot feature may enable this feature while in discovery mode allowing them to sense other nearby Wi-Fi® enabled devices. While in discovery mode, electronic devices 306A-F as well as the target device 308 may enable all wireless technologies that they are capable of operating, such as Bluetooth® or Wi-Fi®, in an attempt to pinpoint the target device 308 location.

Referring to FIGS. 1 and 2, devices 306A, 306D, and 306F sense the target device 308 at 208 and recognize that the specific ID of the target device 308 matches the specific ID made subject of the search request generated at 200 or 202A. Devices 306A, 306D, and 306F may then transmit data about their geographical location back to the server 302 at 210. The data may include, but is not limited to, GPS coordinates, IP addresses, or cell tower/satellite identities. When the server 302 receives the data from responding devices 306A, 306D, and 306F, it may transmit the data to the user device 300 at 212 thereby allowing the user to locate the target device 308. The system may attempt to analyze the data before forwarding it to the user at 212, including attempts to triangulate the location of the target device 308 when numerous devices respond in a general area. If the target device 308 had only cellular, satellite or equivalent capabilities, the system may attempt to locate it through triangulation of nearby telecom towers or satellites that recognize its specific ID from the search request generated at 200 or 202A.

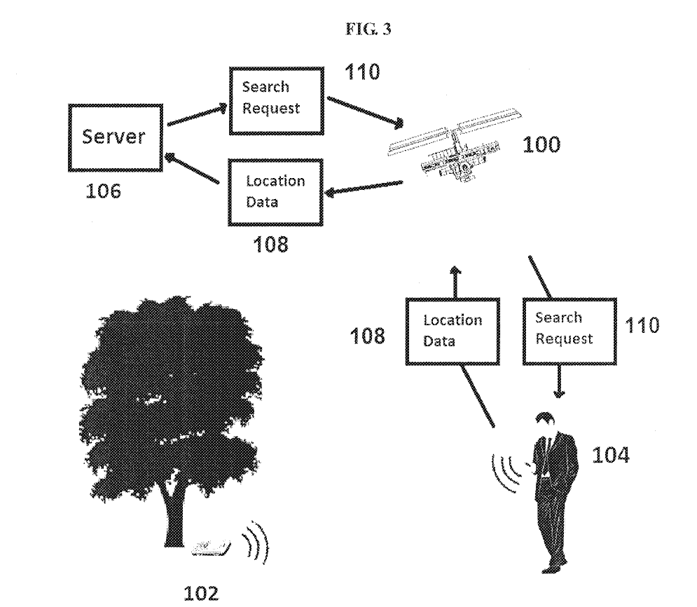

FIG. 3 shows by way of a non-limiting example, how one embodiment of the disclosed system performs. The target device 102 is a Bluetooth enabled portable music storage and playback device with no other wireless capability, and has been lost outside by a tree. After receiving input including the specific ID of the target device 102 from a user via a software application on the user's device 300, the server 106 would forward a search request 110 through all available networks. Device 104 is a smartphone being used by a person geographically near the target device 102. This person is not the user. The person is running software on device 104 which enables it to receive search requests 110 sent by the server 302 through applicable networks 304A, 304B, 304C thereby allowing the system to work. The software may be an application purchased from the service operating the server 302. Device 104 then receives the search request 110 from the network via a satellite or telecom tower 100. Device 104 would enter discovery mode, enabling all wireless technologies it has available, such as Wi-Fi®, mobile hotspot, Bluetooth®, etc. Device 104 would then sense target device 102 on all the wireless technologies they share that are in range. In the example, device 104 would sense the target device 102 using Bluetooth. Device 104 would transmit data 108 about its location in forms such as GPS coordinates or IP Address, through the network via satellite or telecom tower 100 back to the server 106, which would forward the information to the user. Many different wireless technologies allow for many variations of this example, and so this example should not be regarded as definitive of the invention.

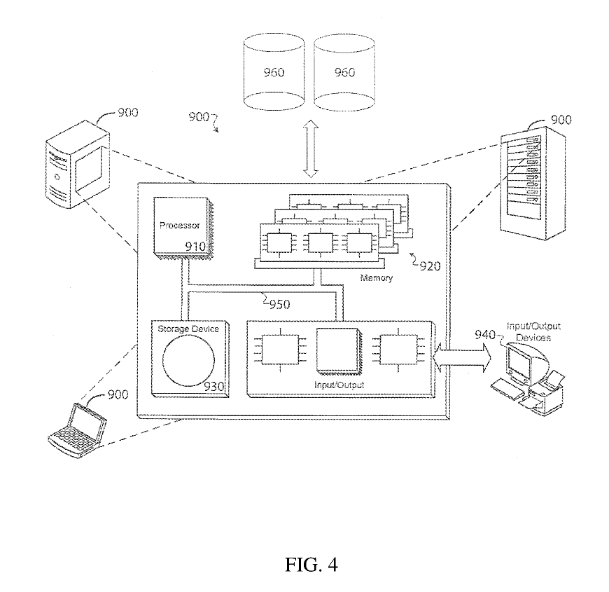

FIG. 4 shows a general purpose computer on which the system and method of the present disclosure may be implemented. The computer system 900 may execute at least some of the operations described above. Computer system 900 may include processor 910, memory 920, storage device 930, and input/output devices 940. Some or all of the components 910, 920, 930, and 940 may be interconnected via system bus 950. Processor 910 may be single or multi-threaded and may have one or more cores. Processor 910 may execute instructions, such as those stored in memory 920 or in storage device 930. Information may be received and output using one or more input/output devices 940.

Memory 920 may store information and may be a computer-readable medium, such as volatile or nonvolatile memory. Storage device 930 may provide storage for system 900 and may be a computer-readable medium. In various aspects, storage device 930 may be a flash memory device, a floppy disk device, a hard disk device, an optical disk device, or a tape device.

Input/output devices 940 may provide input/output operations for system 900. Input/output devices 940 may include a keyboard, pointing device, and microphone. Input/output devices 940 may further include a display unit for displaying graphical user interfaces, speaker, and printer. External data, such as financial data, may be stored in accessible external databases 960.

The features described may be implemented in digital electronic circuitry, or in computer hardware, firmware, software, or in combinations thereof. The apparatus may be implemented in a computer program product tangibly embodied in an information carrier, e.g., in a machine-readable storage device or in a propagated signal, for execution by a programmable processor, and method steps may be performed by a programmable processor executing a program of instructions to perform functions of the described implementations by operating on input data and generating output.

The described features may be implemented in one or more computer programs that are executable on a programmable system including at least one programmable processor coupled to receive data and instructions from, and to transmit data and instructions to, a data storage system, at least one input device, and at least one output device. A computer program may include a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions may include, by way of example, both general and special purpose microprocessors, and the sole processor or one of multiple processors of any kind of computer. Generally, a processor may receive instructions and data from a read only memory or a random access memory or both. Such a computer may include a processor for executing instructions and one or more memories for storing instructions and data. Generally, a computer may also include, or be operatively coupled to communicate with, one or more mass storage devices for storing data files, such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be linked by any form or medium of digital data communication such as a communication network. Examples of communication networks may include, e.g., a LAN, a WAN, and the computers and networks forming the Internet.

The computer system may include clients and servers. A client and server may be remote from each other and interact through a network, such as the network described above. The relationship of client and server may arise by virtue of computer programs running on the respective computers and having a client-server relationship with each other.

Numerous additional modifications and variations of the present disclosure are possible in view of the above teachings. It is therefore to be understood that within the scope of the appended claims, the present disclosure may be practiced other than as specifically described herein.

What is claimed:

1. A process for locating a target device, the process comprising:
generating a search request seeking the target device;
forwarding the search request by a server to one or more devices linked to the server through one or more networks;
wirelessly sensing nearby electronic devices by the one or more linked devices;
receiving a signal from at least one of the one or more linked devices which have sensed the target device; and
transmitting data from the at least one linked device that has sensed the target device to the server.

2. The process of claim 1, wherein the search request includes a device-specific identification of the target device.

3. The process of claim 1, wherein the search request is a user-generated search request received at the server.

4. The process of claim 2, wherein the user-generated search request is generated on a user device.

5. The process of claim 1, wherein the search request is generated at a server in response to a prompt from a user.

6. The process of claim 1, wherein prior to wirelessly sensing, at least one of the one or more linked devices enters a mode enabling the at least one linked device to wirelessly sense other electronic devices.

7. The process of claim 1, wherein the data includes a geographical location of the at least one linked device that has sensed the target device.

8. The process of claim 6, wherein the geographical location comprises one or more of GPS coordinates, IP addresses, cell tower identities, and satellite identities.

9. The process of claim 6, further comprising, after transmitting the geographical location of the at least one linked device to the server, transmitting, by the server, the geographical location to a user device linked to the server.

10. The system of claim 8, further comprising processing the geographical location of the at least one linked device prior to transmitting by the server.

11. The system of claim 9, wherein the processing includes triangulation of two or more geographical locations.

12. The system of claim 1, wherein the forwarding is to one or more devices running software which enables the one or more devices to receive search requests.

13. A system for locating a target device, the system comprising:
a server linked to one or more networks; and
electronic devices linked to the server through the one or more networks;
wherein, upon receiving a search request from the server identifying a target device, the linked electronic devices wirelessly sense other electronic devices within range and the linked electronics device sensing the target device transmits a location to the server.

14. The system of claim 13, wherein one or more of the linked electronic devices include a mode enabling sensing of other electronic devices.

15. The system of claim 13, further comprising a user device linked to the server.

16. The system of claim 15, wherein the server receives a prompt from the user device.

17. The system of claim 12, wherein the electronic devices include software configured to run on the devices, the software enabling the devices to receive search requests.

18. A locating system comprising:
a server linked to one or more networks;
one or more wireless technology-enabled electronic devices linked to the server through the one or more networks;
a WPAN-enabled target device; and
a user device including software configured to communicate a prompt to the server, the prompt including an identification of the target device;
wherein, upon receiving the prompt from the user device, the server transmits to the one or more electronic devices a search request including the identification of the target device, the search request enabling all wireless technologies of the one or more electronic devices to enter a discovery mode to sense other electronic devices;
wherein, at least one of the one or more electronic devices senses the target device and transmits geographical location data of the electronic device to the server; and the server communicates the location to the user device.

19. The system of claim 18, wherein the target device is a WPAN-enabled target device.
